(19) United States
(12) Patent Application Publication
(10) Pub. No.: US 2013/0129612 A1
(43) Pub. Date: May 23, 2013

(54) Process for Ion Exchange on Zeolites

(71) Applicant: BASF SE, Ludwigshafen (DE)

(72) Inventors: Hermann Luyken, Ludwigshafen (DE); Manuela Gaab, Schwetzingen (DE); Rolf-Hartmuth Fischer, Heidelberg (DE)

(73) Assignee: BASF SE, Ludwigshafen (DE)

(21) Appl. No.: 13/677,868

(22) Filed: Nov. 15, 2012

Related U.S. Application Data
(60) Provisional application No. 61/561,298, filed on Nov. 18, 2011.

(51) Int. Cl. C01B 39/50

(52) U.S. Cl. CPC C01B 39/50
USPC 423/713

(57) ABSTRACT

Aspects of the present invention relate to an improved process for exchanging alkali metal or alkaline earth metal ions in zeolites for ammonium ions. For this exchange, aqueous solutions of ammonium salts, for example ammonium sulfate, ammonium nitrate or ammonium chloride, are currently being used. The resulting “ammonium zeolites” are calcined to convert them, with release of ammonia, to the H form of the zeolites suitable as a catalyst. Certain methods provided herein use ammonium carbonate instead of the ammonium compounds mentioned. As excess ammonium carbonate, in contrast to the nitrates, sulfates or chlorides, can be recycled in the form of carbon dioxide and ammonia, the amount of salt which has to be discharged is lowered significantly.

### CROSS-REFERENCE TO RELATED APPLICATIONS

This application claims priority to U.S. Provisional Application No. 61/561,298, filed Nov. 18, 2011, the entire contents of which are incorporated by reference in their entirety.

### FIELD

The present invention relates to processes for exchanging alkali metal or alkaline earth metal ions in zeolites for ammonium ions.

### BACKGROUND

The high demand in petrochemistry for lower hydrocarbons such as saturated and unsaturated aliphatic, cycloaliphatic or aromatic hydrocarbons is satisfied by conversion processes such as catalytic cracking, hydrocracking or thermal cracking. The feedstocks used are crude oils or relatively high-boiling crude oil distillate fractions.

In catalytic cracking, preference is given to working with fluidized beds consisting of zeolites (FCC processes). The zeolites are used in the H form, which can be produced by heating corresponding zeolites comprising ammonium ions to about 400° C. (Hans-Jurgen Arpe, Industrielle organische Chemie [Industrial Organic Chemistry], 6th edition, 2007, Wiley-VCH publishers, pages 64 to 65).

For instance, U.S. Pat. No. 3,966,882 describes the exchange of Na for NH₄ ions Ammonium carbonate is not mentioned.

U.S. Re 28,629 and U.S. Pat. No. 4,346,067 disclose using ammonium chloride, ammonium nitrate or ammonium sulfate for ion exchange.

U.S. Pat. No. 4,346,067 also mentions that, apart from the ammonium compounds, urea may also be present. Tables I and II in example 1C show that, with aqueous urea in the absence of ammonium compounds, 9.18-8.17%=0.61% of the original amount of Na is still exchanged. This can be explained by hydrolysis of the urea to ammonium carbonate and subsequent ion exchange.

CN 102623650 mentions that ammonium carbonate is used for ion exchange.

The exchange between zeolite comprising alkali metal or alkaline earth metal ions, for example a sodium Y zeolite, and an ammonium salt, for example ammonium nitrate, constitutes an equilibrium reaction. In order to exchange the sodium ions very substantially for ammonium ions, the zeolite has to be treated several times in succession, preferably at temperatures of 70° C. to 100° C., in some cases to 200° C., with an excess of aqueous ammonium nitrate relative to the sodium ions. After the ion exchange step, the salt solution is generally separated from the zeolite. The solid zeolite can subsequently be washed with water in order to remove salts. After each ion exchange step, it is calcined at 200° C. to 600° C. In the course of this, ammonia release forms the desired H form of the zeolite (Ullmann's Encyclopedia of Industrial Chemistry, 6th edition, volume 39, 2003, Wiley-VCH publishers, pages 638 to 640).

As a result of the ion exchange and the calcination, the Y zeolite in the H form and an aqueous salt solution comprising a mixture of sodium nitrate and unconverted ammonium nitrate are obtained. Since the replacement of the sodium ions by the ammonium ions is incomplete, ammonium compounds are present alongside the sodium compounds in the mother liquor.

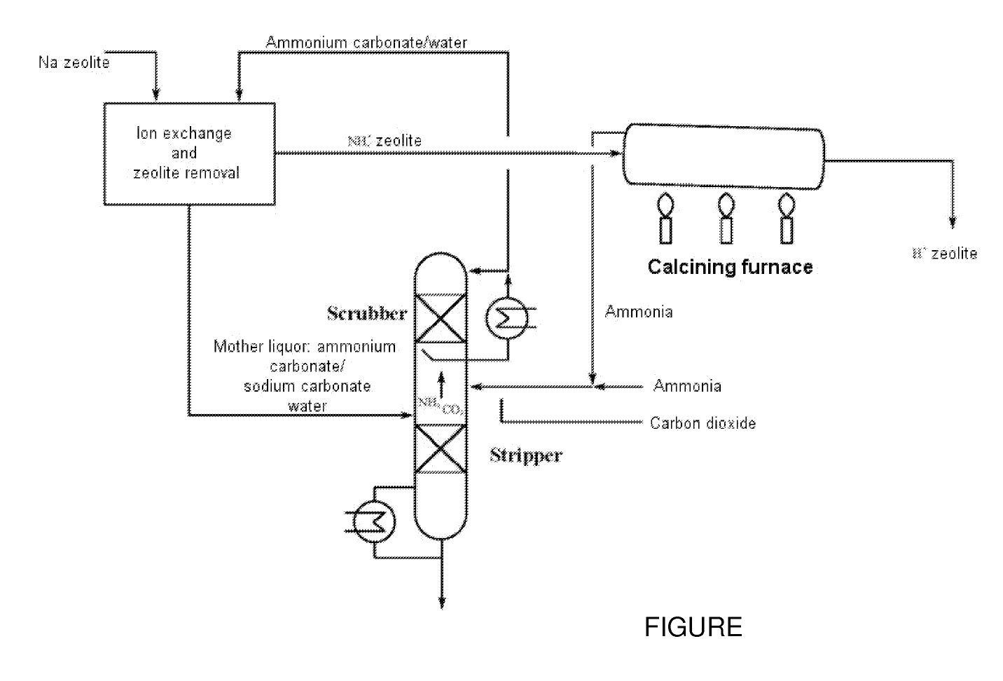

The thermal release of ammonia and carbon dioxide from an aqueous ammonium carbonate solution is described in WO 2009/036145. For instance, FIG. 1 shows that ammonia and water are first released from ammonium hydrogencarbonate/sodium carbonate mixtures and the remaining sodium hydrogencarbonate is converted to sodium carbonate with release of carbon dioxide.

Hollemann-Wiberg, Lehrbuch der Anorganischen Chemie [Inorganic Chemistry], 102nd edition (2007), Walter de Gruyter publishers, page 671, “Ammoniumcarbonat” section, it is known that ammonium carbonate can be produced by introducing carbon dioxide into aqueous ammonia.

One disadvantage in the prior art processes is that large amounts of aqueous sodium nitrate and ammonium nitrate solution, sodium sulfate and ammonium sulfate solution or sodium chloride and ammonium chloride solution are formed, which are obtained, for example, in the case of use of ammonium nitrate, ammonium sulfate or ammonium chloride for the ion exchange of zeolites comprising sodium ions.

The salt solutions can in principle be used for production of fertilizers. However, this means only a low level of added value. Moreover, the economic viability of utilization as a fertilizer depends on the site.

The ammonia bound in the ammonium salts can be released by addition of at least equimolar amounts of sodium hydroxide solution, removed by stripping or distillation and reused for the preparation of the ammonium salts. However, this addition of value is reduced by the consumption of sodium hydroxide solution. There remains a large amount of the respective aqueous sodium salt solution. If there is no means of further use, it has to be disposed of. The known processes require high circulation rates with a considerable energy requirement, which constitutes an economic disadvantage.

### SUMMARY

One aspect of the invention relates to a method for exchanging sodium ions in sodium-comprising zeolites for ammonium ions, the method comprising: a) treating a sodium-comprising zeolite with a solution comprising water and ammonium carbonate to provide a mother liquor comprising aqueous sodium carbonate and ammonium carbonate; b) separating the zeolite from the mother liquor; and c) thermally treating the mother liquor to release ammonia and carbon dioxide.

In one or more embodiments, thermally treating the mother liquor to release ammonia and carbon dioxide comprises stripping. In some embodiments, the method further comprises recombining the released ammonia and carbon dioxide to form ammonium carbonate. In one or more embodiments, the method further comprises repeating a) through c), wherein the ammonium carbonate formed is recycled in a).

In some embodiments, the treated zeolite is calcined prior to the ion exchange. In one or more embodiments, the method further comprises repeating a) through c), wherein the ammonia formed in c) is converted to ammonium carbonate with addition of carbon dioxide and recycled into step a).

In one or more embodiments, the method further comprises discharging the aqueous sodium carbonate solution obtained in c) from the process. In some embodiments, the method further comprises washing the zeolite separated in b) with water to provide a wash water. In further embodiments, the wash water obtained is separated from the zeolite and added to the mother liquor prior to process c).

In some embodiments, in step a), the solution comprising water and ammonium carbonate is prepared from water and ammonium carbonate and optionally further compounds. In one or more embodiments, the further compounds comprise urea and/or ammonium carbamate and/or mixtures of carbon dioxide and ammonia.

In one or more embodiments, in step a), the solution comprising water and ammonium carbonate is prepared from water and urea and/or ammonium carbamate and/or mixtures of carbon dioxide and ammonia. In some embodiments, in step c), thermally treating the mother liquor comprises addition of a base. In one or more embodiments, the base is an aqueous solution of sodium hydroxide.

### BRIEF DESCRIPTION OF THE DRAWING

The FIGURE shows a process according to one or more embodiments of the invention.

### DETAILED DESCRIPTION

The present invention relates to an improved process for exchanging alkali metal or alkaline earth metal ions in zeolites for ammonium ions. For this exchange, aqueous solutions of ammonium salts, for example ammonium sulfate, ammonium nitrate or ammonium chloride, are currently being used. The resulting “ammonium zeolites” are calcined to convert them, with release of ammonia, to the H form of the zeolites suitable as a catalyst.

It is proposed in accordance with the invention to use ammonium carbonate instead of the ammonium compounds mentioned. Since excess ammonium carbonate, in contrast to the nitrates, sulfates or chlorides, can be recycled in the form of carbon dioxide and ammonia, the amount of salt which has to be discharged is lowered significantly.

Accordingly, one or more aspects of the invention provide a process which does not have the abovementioned disadvantages.

More particularly, one or more aspects of the present invention to recover the ammonium present in the salt solution obtained in the ion exchange, and optionally additionally the corresponding counterion, to increase the economic viability.

One or more aspects of the invention provide a process for exchanging sodium ions in sodium-comprising zeolites for ammonium ions, which comprises

a) treating the sodium-comprising zeolite with a solution comprising water and ammonium carbonate,

b) separating the zeolite from the solution (mother liquor) comprising aqueous sodium carbonate and ammonium carbonate, and

c) thermally treating the mother liquor to release ammonia and carbon dioxide.

Ion Exchange

For the ion exchange, natural or synthetic crystalline zeolites which comprise alkali metal or alkaline earth metal ions are suitable.

In one or more embodiments, the ions are selected from sodium, potassium, calcium and magnesium ions, particular preference to sodium ions.

All zeolites comprising alkali metal and alkaline earth metal ions are suitable in principle. In some embodiments, the selected zeolites comprise those of the ZSM type, especially ZSM-5, and also X, Y, A and L zeolites. Other options are naturally occurring zeolites such as faujasite, chabazite, erionite, mordenite, offretite (U.S. Pat. No. 4,346,067, column 1, lines 43 to 57). In one or more embodiments, the selected zeolites comprise Y zeolites in the sodium form.

In order to obtain effective catalytic cracking catalysts, the alkali metal content of the zeolite should be lowered by ion exchange to less than 10% by weight, or less than 5% by weight, or less than 1% by weight.

The solution comprising water and ammonium carbonate may be prepared from water and ammonium carbonate and optionally further compounds.

In one or more embodiments, the further compounds are those which give rise to ammonium carbonate under the reaction conditions of the ion exchange with water.

Among these further compounds, included are urea, ammonium carbamate, mixtures of carbon dioxide and ammonia, and mixtures thereof. In a further embodiment of the invention, these further compounds may also be used instead of ammonium carbonate.

Ammonium carbonate may be used for the ion exchange as an aqueous solution of strength 0.1% by weight up to the solubility limit, or 5 to 35% by weight, or 10 to 25% by weight Ammonium carbonate is understood to mean (NH₄)₂CO₃, NH₄HCO₃ and mixtures thereof.

Instead of ammonium carbonate or in a mixture with ammonium carbonate, it is also possible to use, for the ion exchange, compounds which form ammonium carbonate in aqueous solution under the reaction conditions. Examples thereof are urea and ammonium carbamate.

It is also possible to dissolve carbon dioxide and ammonia, for instance in a molar ratio of 1 to 2, in water and react them with the suspended zeolite.

The reaction of, for example, urea and/or ammonium carbamate with water can be effected in a separate reaction step prior to the ion exchange. However, it is also possible to conduct the reaction of urea and/or ammonium carbonate and the ion exchange in the same process step.

The ion exchange is performed at temperatures of 0° C. to 200° C., or 20° C. to 100° C., or 50° C. to 80° C., and total pressures of 1 to 300 bar, or 1 to 50 bar, or 1 to 10 bar.

The ion exchange can be effected batchwise or continuously.

The zeolite can be suspended in the aqueous stirred ammonium carbonate solution. However, it is also possible to arrange the zeolite in fixed bed form, for example in a tubular reactor, and to pump the aqueous ammonium carbonate solution over the zeolite in liquid phase or trickle mode and to conduct the ammonium carbonate solution in circulation or in straight pass.

In one or more embodiments, the zeolite and the ammonium carbonate solution can flow through a tube, and in even further embodiments, conducting the solution in countercurrent to the zeolite.

In some embodiments, the ion exchange is conducted in one or more belt filters. The mother liquor from the downstream filter can be recycled in countercurrent to the previous filter.

In one or more embodiments, the ion exchange is performed in a combination of one or more stirred tanks or one or more flow tubes and one or more belt filters in succession and in countercurrent.

The reaction time needed for the ion exchange is 0.1 second to 10 hours, or 1 second to 2 hours, or 1 second to 1 hour.

Zeolite Removal and Calcination

Zeolite suspended in aqueous ammonium carbonate solution can be removed, for example, by filtration or centrifugation.

In order to remove salts adhering to the zeolite, it can be washed once or more than once with water. In one or more embodiments, it is washed one to three times with water. The amount of water may be about 1 to 1000 g of water per g of zeolite.

The wash water can be combined with the salt solution removed from the zeolite.

The calcined zeolite can optionally be passed onward into a second ion exchange stage a).

The cycle sequence of ion exchange, zeolite removal and calcination is optionally repeated until the sodium content of the zeolite has fallen to the desired value. In general, 1 to 3 cycles and especially 1 to 2 cycles are needed for this purpose.

Thermal release of ammonia and carbon dioxide from the excess aqueous ammonium carbonate solution (mother liquor)

The excess ammonium carbonate solution which has been removed from the zeolite after the ion exchange additionally comprises sodium carbonate.

This solution can be combined with the wash water if the zeolite has been washed with water.

The mixture of ammonium carbonate solution and sodium carbonate solution and water is heated to a temperature above 50° C., or above 60° C. There is in principle no upper limit to the temperature, but temperatures above 100° C. may require an elevated pressure. The heating can be performed batchwise or continuously. Evaporation of a portion of the liquid results in escape of carbon dioxide and possibly ammonia.

In one or more embodiments, the mixture is supplied continuously to a distillation column The liquid in the bottom of the column is heated and partly evaporated by introduction of heat or steam Ammonium carbonate decomposes along the plates of the column, and carbon dioxide and ammonia formed are stripped out of the liquid by the ascending vapor. In the bottom, a solution depleted of ammonium carbonate is obtained. In some embodiments, the bottoms comprise barely any or no ammonium carbonate.

If desired, the thermal release is effected with addition of a base. In one or more embodiments, the bases are alkali metal hydroxide and/or alkaline earth metal hydroxide. These can be added in solid form or as a solution, preferably as an aqueous solution.

In embodiments in which a base is added as an aqueous solution, a concentration of 0.1% by weight to 50% by weight may be used, and in further embodiments, a concentration of 10% by weight to 50% by weight.

In one or more embodiments, and aqueous solution of sodium hydroxide (sodium hydroxide solution) with a concentration of 0.1% by weight to 50% by weight is used. In further embodiments, an aqueous solution of sodium hydroxide (sodium hydroxide solution) with a concentration of 10% by weight to 50% by weight is used.

Recycling of Ammonia and Carbon Dioxide

Carbon dioxide and ammonia, which are obtained as low boilers from the thermal treatment, can be recombined by cooling for recovery. They may be recombined in aqueous solution. In some embodiments, recovery is carried out by condensation and cooling of the liquid stream, the liquid stream being used for absorption of gaseous carbon dioxide and ammonia.

The aqueous ammonium carbonate solution can be reused for the ion exchange.

However, it is also possible to introduce ammonia and carbon dioxide directly into the aqueous ammonium carbonate solution used for the ion exchange.

Discharge of Aqueous Sodium Carbonate Solution

The bottom product obtained from the thermal treatment is an aqueous sodium carbonate solution, which is discharged from the process.

Sodium carbonate (soda) is one of the most important products in the large-scale chemical industry, which is optionally used instead of NaOH. Annual global production is on the 50 megatonne scale (Hollemann-Wiberg, Lehrbuch der Anorganischen Chemie, 102nd edition (2007), Walter de Gruyter publishers, page 1291)

Therefore, the options for utilization of aqueous sodium carbonate solution are much more favorable than those for aqueous ammonium nitrate/sodium nitrate, ammonium sulfate/sodium sulfate or ammonium chloride/sodium chloride solutions.

The FIGURE shows one or more embodiments of the process according to the invention. The sodium zeolite is treated in an ion exchanger stage with an aqueous ammonium carbonate solution. Thereafter, treated zeolite and mother liquor are separated by a suitable process, for example filtration, and optionally dried. The zeolite thus pretreated is calcined in a furnace, releasing ammonia. These stages can be conducted twice or more in succession. The mother liquor from the removal stage is supplied to a column which comprises a stripping section and is heated at the bottom with an evaporator or by direct addition of steam. The temperature increase drives out ammonia and carbon dioxide, entraining water in the form of steam. The vaporous mixture is condensed in a direct or indirect condenser, and ammonia and carbon dioxide recombine with water to give aqueous ammonium carbonate. The ammonium carbonate solution thus obtained is recycled into the ion exchange stage. Via the bottom of the column, an aqueous sodium carbonate solution is discharged. The ammonia from the calcining furnace is optionally conducted with supplementary ammonia and carbon dioxide into the column upstream of the condenser.

### EXAMPLES

The invention is illustrated in detail by the examples and comparative examples which follow, but without being restricted thereto.

The examples which follow describe the inventive sodium exchange in zeolite Y using ammonium carbonate. The zeolite Y used, having a sodium content of 7.3% by weight, was purchased under the CBV 100 brand name from Zeolyst. For example 9 and comparative example 12, USY (X6503, Engelhardt) with a sodium content of 3.1% by weight was used. Chemical analyses of the ammonium carbonate or ammonium nitrate solutions used, prior to treatment of the zeolite, showed a sodium content of <0.01% by weight. All sodium contents specified hereinafter were determined analogously by means of chemical analysis. Prior to performance of the experiments, the zeolite used in each case was calcined at 500° C. for 5 hours. XRD analyses of selected samples on completion of treatment confirmed that the zeolite structure was intact after the ion exchange.

The sodium content was determined by means of flame atomic absorption spectrometry, and the ammonium content according to Kjeldahl. The inorganic carbon was determined as carbon dioxide by means of thermal conductivity measurements after combustion of the sample in an oxygen stream.

Ion Exchange

### Example 1

100 g of ammonium carbonate were dissolved in 1000 g of water and heated to 80° C. 100 g of zeolite were suspended in the solution and heated while stirring for 2 hours. Thereafter, the suspension was filtered. The filtrate had an increased sodium content of 0.4% by weight. The filtered zeolite was treated again in an ammonium carbonate solution composed of 100 g of ammonium carbonate and 1000 g of water, which had been heated to 80° C., for 2 hours. This was followed by filtration and washing of the zeolite with 1800 g of water.

Thereafter, the filtrate had a sodium content of 0.1% by weight. The filtercake was dried at 120° C. for 4 hours and then calcined at 500° C. for 5 hours. The sodium content of the zeolite after calcination was 2.7% by weight.

### Example 2

The procedure corresponded to Example 1. The treatment of the zeolite with the ammonium carbonate solution was extended both times from 2 hours to 14 hours. The sodium content of the zeolite thereafter was 2.5% by weight.

### Example 3

The procedure corresponded to Example 1. The treatment of the zeolite with the ammonium carbonate solution was conducted both times at 60° C. rather than 80° C. The sodium content of the zeolite thereafter was 2.5% by weight.

### Comparative Example 4

The procedure corresponded to Examples 1 to 3, except that the treatment of the zeolite was performed with ammonium nitrate solutions.

The sodium contents of the ammonium nitrate solutions after treatment of the zeolite were in all cases comparable with the sodium contents of the ammonium carbonate solutions. The sodium content of the zeolite after treatment with ammonium nitrate was 2.3-2.6% by weight.

### Example 5

50 g of ammonium carbonate were dissolved in 500 g of water and heated to 60° C. 50 g of the zeolite were suspended in the solution and heated for 2 hours. Thereafter, the suspension was filtered. The filtrate had an increased sodium content of 0.5 to 0.6% by weight. The filtered zeolite was treated again in an ammonium carbonate solution composed of 50 g of ammonium carbonate and 500 g of water, which had been heated to 60° C., for 2 hours. This was followed by filtration and washing of the zeolite with 1500 g of water. The filtrate thereafter had a sodium content of 0.1% by weight. The filtercake was dried at 120° C. for 4 hours and then calcined at 500° C. for 5 hours. The sodium content of the zeolite after calcination was 2.3 to 2.6% by weight.

### Example 6

The procedure corresponded to Example 5, except that the treatment of the zeolite was performed with ammonium oxalate. The sodium content of the zeolite after the calcination was 2.6% by weight.

### Comparative Example 7

The procedure corresponded to Example 5, except that the treatment of the zeolite was performed with ammonium nitrate. The sodium contents of the filtrates were 0.5% and 0.1% by weight. The sodium content of the zeolite after the calcination was 2.3% by weight.

### Example 8

50 g of ammonium carbonate were dissolved in 500 g of water and heated to 60° C. 50 g of the zeolite were suspended in the solution and heated for 2 hours. Thereafter, the suspension was filtered and washed with 1500 g of water. The filtrate had an increased sodium content of 0.4% by weight. The filtercake was dried at 120° C. for 4 hours and then calcined at 500° C. for 5 hours. The calcined powder was treated again in an ammonium carbonate solution composed of 50 g of ammonium carbonate and 500 g of water, which had been heated to 60° C., for 2 hours. This was followed by filtration and washing of the zeolite with 1500 g of water. The filtrate thereafter had a sodium content of 0.1% by weight. The filtercake was dried at 120° C. for 4 hours and then calcined at 500° C. for 5 hours. The sodium content of the zeolite at the end of the treatment was 1.9% by weight.

### Example 9

The procedure corresponded to Example 8. USY (X6503, Engelhardt, sodium content 3.1% by weight) was used. The sodium content of the zeolite after the calcination was 1.0% by weight.

### Example 10

The procedure corresponded to Example 8, except that the treatment of the zeolite was performed with ammonium oxalate. The sodium contents of the filtrates were 0.4% and 0.1% by weight. The sodium content of the zeolite after the calcination was 2.0% by weight.

### Comparative Example 11

The procedure corresponded to Example 8, except that the treatment of the zeolite was performed with ammonium nitrate. The sodium contents of the filtrates were 0.4% and 0.1% by weight. The sodium content of the zeolite at the end of the treatment was 1.4% by weight.

### Comparative Example 12

The procedure corresponded to Comparative Example 11. USY (X6503, Engelhardt, sodium content 3.1% by weight) was used. The sodium content of the zeolite after the calcination was 0.8% by weight.

### Example 13

15 g of the zeolite were suspended in 165 g of ammonia solution (7%). Thereafter, 5 bar of CO₂ were injected and the mixture was stirred at 60° C. for 2 hours. Filtration was followed by washing with 1000 mL of water. The filtrate had an increased sodium content of 0.3% by weight. The filtercake was dried at 120° C. for 4 hours and then calcined at 500° C. for 5 hours. The sodium contents of the zeolite after the calcination were 3.4 to 3.6% by weight. The calcined powder was suspended again in 165 g of ammonia solution (7%) and stirred with 5 bar of CO₂ at 60° C. for 2 hours. This was followed by filtration, drying and calcination as described above. The sodium content of the second filtrate was 0.1% by weight, and that of the zeolite at the end of the treatment was 2.3% by weight.

### Example 14

The procedure corresponded to Example 13, except that 7% ammonia solution and 2 bar of CO₂ were employed. The sodium content of the first filtrate was 0.2 to 0.3% by weight. The sodium content of the zeolite after the first calcination was 3.4 to 3.8% by weight. The sodium content of the second filtrate was 0.1% by weight. The sodium content of the zeolite at the end of the treatment was 2.6% by weight.

### Example 15

The procedure corresponded to Example 13, except that 3% ammonia solution and 5 bar of CO₂ were employed. The sodium content of the first filtrate was 0.3% by weight. The sodium content of the zeolite after the first calcination was 3.6% by weight. The sodium content of the second filtrate was 0.1% by weight. The sodium content of the zeolite at the end of the treatment was 2.5% by weight.

### Example 16

The procedure corresponded to Example 13, except that 3% ammonia solution and 2 bar of CO₂ were employed. The sodium content of the first filtrate was 0.2% by weight. The sodium content of the zeolite after the first calcination was 4.0% by weight. The sodium content of the second filtrate was 0.1% by weight. The sodium content of the zeolite at the end of the treatment was 2.1% by weight.

### Example 17

The procedure corresponded to Example 13, except that the treatment of the zeolite was performed with 3% ammonia solution and 1 bar of CO₂. The sodium contents of the two filtrates were 0.2% and 0.1% by weight. The sodium content of the zeolite at the end of the treatment was 3.4% by weight.

### Example 18

The procedure corresponded to Example 13, except that the treatment of the zeolite was performed with 1% ammonia solution and 1 bar of CO₂. The sodium contents of the two filtrates were 0.2% and 0.1% by weight. The sodium content of the zeolite at the end of the treatment was 3.2% by weight.

Thermal release of ammonia and carbon dioxide from the excess aqueous ammonium carbonate solution (mother liquor)

### Example 19

50 g of ammonium carbonate were initially charged in 500 g of water and heated to 60° C. 50 g of USY (X6503, Engelhardt, sodium content 3.1% by weight) were suspended in the solution and heated while stirring for 2 hours. Thereafter, the suspension was filtered. The filtrate had an increased sodium content of 0.3% by weight. The mixture was heated at 100° C. while stirring for several hours. Samples were taken after 1, 3 and 24 hours and the contents of ammonium ions and inorganic carbon were determined (see table below). The decrease in the two values indicates the thermal decomposition of the ammonium carbonate used to ammonia and carbon dioxide.

| | | | | |
|---|---|---|---|---|
| Treatment time at | 0 | 1 | 3 | 24 |
| 100° C. [h] | (directly after filtration) | | | |
| Ammonium content [%] | 2.3 | 0.6 | 0.4 | 0.2 |
| Inorganic carbon [%] | 0.9 | 0.2 | 0.1 | 0.1 |

What is claimed is:

1. A method for exchanging sodium ions in sodium-comprising zeolites for ammonium ions, the method comprising:
a) treating a sodium-comprising zeolite with a solution comprising water and ammonium carbonate to provide a mother liquor comprising aqueous sodium carbonate and ammonium carbonate;
b) separating the zeolite from the mother liquor; and
c) thermally treating the mother liquor to release ammonia and carbon dioxide.

2. The method of claim 1, wherein thermally treating the mother liquor to release ammonia and carbon dioxide comprises stripping.

3. The method of claim 1, further comprising recombining the released ammonia and carbon dioxide to form ammonium carbonate.

4. The method of claim 3, further comprising repeating a) through c), wherein the ammonium carbonate formed is recycled in a).

5. The method of claim 1, wherein the treated zeolite is calcined prior to the ion exchange.

6. The method of claim 5, further comprising repeating a) through c), wherein the ammonia formed in c) is converted to ammonium carbonate with addition of carbon dioxide and recycled into step a).

7. The method of claim 1, further comprising discharging the aqueous sodium carbonate solution obtained in c) from the process.

8. The method of claim 1, further comprising washing the zeolite separated in b) with water to provide a wash water.

9. The method of claim 8, wherein the wash water obtained is separated from the zeolite and added to the mother liquor prior to process c).

10. The method of claim 1, wherein, in a), the solution comprising water and ammonium carbonate is prepared from water and ammonium carbonate and optionally further compounds.

11. The method of claim 10, wherein the further compounds comprise urea and/or ammonium carbamate and/or mixtures of carbon dioxide and ammonia.

12. The method of claim 1, wherein, in a), the solution comprising water and ammonium carbonate is prepared from water and urea and/or ammonium carbamate and/or mixtures of carbon dioxide and ammonia.

13. The method of claim 1, wherein, in c), thermally treating the mother liquor comprises addition of a base.

14. The method of claim 13, wherein the base is an aqueous solution of sodium hydroxide.

15. The method of claim 14, wherein the base is at a concentration of about 10% to 50% by weight.

16. The method of claim 1, wherein the zeolite comprises a zeolite selected from the group consisting of ZSM-5, X, Y, A L, faujasite, chabazite, erionite, mordenite, offretite, and combinations thereof.
